(19) United States
(12) Patent Application Publication
(10) Pub. No.: US 2009/0165008 A1
(43) Pub. Date: Jun. 25, 2009

(54) APPARATUS AND METHOD FOR SCHEDULING COMMANDS FROM HOST SYSTEMS

(75) Inventors: Chien-Hsing Liu, Taipei (TW); Chih-Hua Lin, Taipei (TW); Shih-Neng Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: ATEN INTERNATIONAL CO., LTD., Taipei (TW)

(21) Appl. No.: 11/960,146

(22) Filed: Dec. 19, 2007

(51) Int. Cl. G06F 9/46

(52) U.S. Cl. 718/103

(57) ABSTRACT

A scheduling apparatus and method thereof are disclosed. The scheduling apparatus includes a command-collecting module, a sorting module and a command-executing module. The command-collecting module collects the commands issued from the host systems. The sorting module sorts the collected commands from the command-collecting module based on a plurality of data addresses. The data addresses within the storage unit are associated with the commands. The command executing module executes the sorted commands from the sorting module.

### FIELD OF THE INVENTION

The present invention relates to a storage system and method thereof, and more particularly to a scheduling apparatus and method for scheduling commands transmitted from a plurality of host systems to a storage system so that the host systems are capable of accessing the storage unit of the storage system rapidly and efficiently.

### BACKGROUND OF THE INVENTION

FIG. 1 is a conventional system diagram depicting a host system for accessing a storage unit 102 connected to a remote storage system 104 computer via a network. The system of accessing the storage unit 102 includes the host system 100, the remote storage system 104 and the storage unit 102 connected to the remote storage system 104. The host system 100 remotely reads/writes the data stored in the storage unit 102 of the remote storage system 104 by employing a network interface card (not shown) installed thereon. The remote storage unit 102 may be a hard disk drive (HDD), a compact disk random only memory (CD-ROM), a floppy drive or other storage devices.

However, time-out of a command might be a problem because the storage unit 102 doesn't directly connect to the host system 100. That is, the waiting time of the commands for accessing the storage unit 102 is too long while the host system 100 transmits the commands to remote storage system 104 and waits for the response of the remote storage system 104. Further, the host system 100 randomly reads/writes the addresses of the storage unit 102 of remote storage system 104 according to the commands, resulting in wasting a lot of input/output time of the storage unit 102. Consequently, since the above-mentioned problems, the storage unit 102 of the remote storage system 104 is only accessed by a user on a host system 100.

### SUMMERY OF THE INVENTION

One objective of the present invention is to provide a scheduling apparatus and method for scheduling commands to reduce the time-out problem of commands.

Another objective of the present invention is to provide a scheduling apparatus and method for scheduling commands to reduce input/output (I/O) time of the storage unit.

According to the above objectives, the present invention sets forth a scheduling apparatus and method thereof. The scheduling apparatus includes a command-collecting module, a sorting module and a command-executing module.

The command-collecting module collects the commands issued from the host systems. The sorting module sorts the collected commands from the command-collecting module based on a plurality of data addresses. The data addresses within the storage unit are associated with the commands. The command executing module executes the sorted commands from the sorting module.

The command-collecting module further includes a command time stamp unit, a command queue, and a condition trigger unit. The command time stamp unit records a plurality of arrival time stamps of the commands from the host systems. That is, the command time stamp unit “stamps” the arrival time when the commands are sequentially received by the command-collecting module. The command queue queues the commands from the command time stamp unit. The condition trigger unit groups the commands in the command queue into a plurality of command groups based on plural condition thresholds. The plural condition thresholds may include condition thresholds such as a command quota and a time slice. The command quota is defined as a data amount being accessed by the commands, and the time slice is defined as a time interval. The condition trigger unit further includes a command quota checker and a time slice checker for checking aforesaid two condition thresholds, respectively. The command quota checker checks the data amount being accessed by the commands based on the command quota of the condition threshold. The time slice checker checks the time interval of the arrival time stamps based on the time slice condition threshold. While either one of the two condition thresholds is reached, the commands queued at the command queue are grouped and transmitted to the sorting module.

The command groups from the sorting module are stored in a command-group pool, wherein each of the command groups has at least one command. The picker unit picks one of the command groups from the command-group pool. The decoder decodes the commands within the picked command group according to the data addresses those would be accessed by the commands. The cache unit stores the data corresponding to the data addresses which are previously accessed by the previous commands. If the data being accessed by the current commands have the same addresses as the data previously accessed by the previous commands, the previously accessed data in the cache unit are transmitted to the host systems directly. If the data being accessed by the current commands have the different addresses from the data previously accessed by the commands, the command executer unit executes the current commands from the decoder and transmits the data at the addresses associated with the executed current commands to the host systems. And meanwhile, the cache unit is updated with the data at the addresses associated with the commands.

The method of scheduling a plurality of commands comprises the steps of:

(1) recording a plurality of arrival time stamps of the commands from the host systems.

(2) grouping the commands in the command queue into a plurality of command groups based on plural condition thresholds. The plural condition thresholds may include condition thresholds such as a command quota and a time slice, wherein the command quota is defined as a data amount being accessed by the commands and the time slice is defined as a time interval. While either one of the two condition thresholds is reached, the commands queued by the command queue are grouped and transmitted to the sorting module.

(3) sorting the commands in each command groups according to the data addresses associated with the commands.

(4) decoding the commands within the one command group according to the data addresses accessed by the commands.

(5) determining whether the data being accessed by the current commands have the same addresses as the data previously accessed by the previous commands. If the data being accessed by the current commands have the same addresses as the data previously accessed by the previous commands, transmitting the previously accessed data in the cache unit to the host systems directly. If the data being accessed by the current commands have the different addresses from the data previously accessed by the commands, executing the current commands from the decoder.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a conventional system diagram depicting a host system for accessing a storage unit connected to remote storage system via a network;

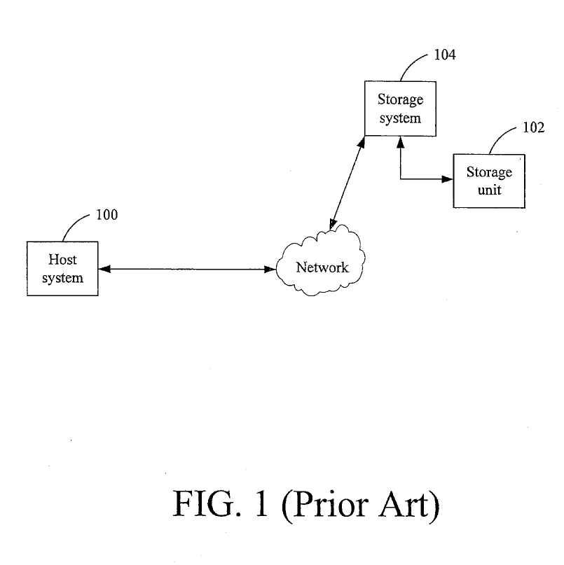

FIG. 2 shows a schematic diagram of an example of a virtual storage system having a scheduling apparatus consistent with the present invention;

FIG. 3 shows a schematic diagram of an example of a command-collecting module of the scheduling apparatus shown in FIG. 2 consistent with the present invention;

FIG. 4 shows a schematic diagram of an example of a command-executing module of the scheduling apparatus shown in FIG. 2 consistent with the present invention;

FIG. 5 shows a diagram illustrating an example of dividing time slices for collecting the commands in a command queue consistent with the present invention;

FIGS. 6A and 6B show a diagram illustrating an example of sorting the commands within a time slice consistent with the present invention; and

FIG. 7 shows a flow chart of performing the scheduling apparatus in the example consistent with the present invention.

### DETAILED DESCRIPTION OF THE INVENTION

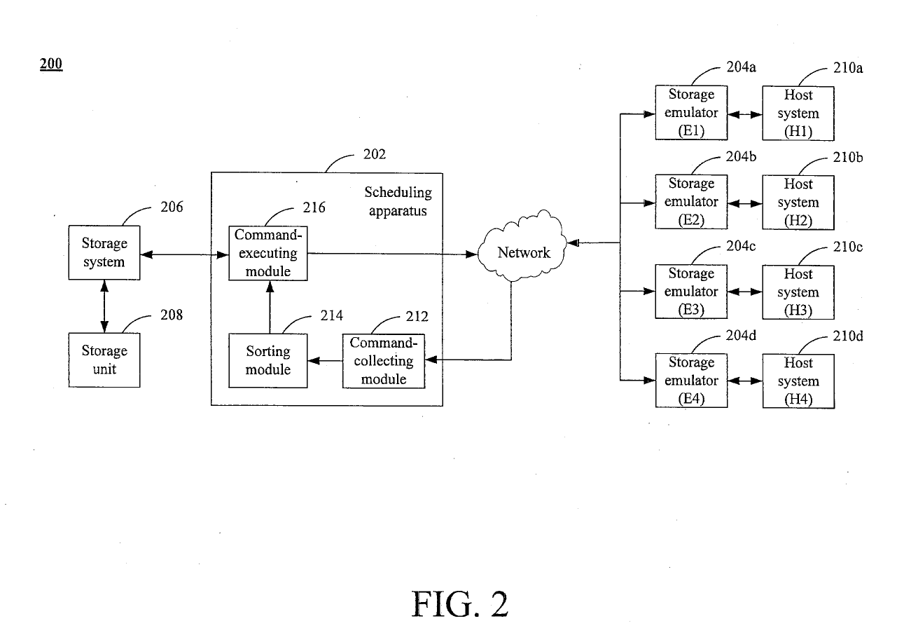

Please refer to FIG. 2 which depicts a schematic diagram of an example of a virtual storage system 200 having a scheduling apparatus 202 consistent with the present invention The virtual storage system 200 mainly includes a scheduling apparatus 202 and a plurality of storage emulators (E1 through E4, 204a through 204d). The scheduling apparatus 202 couples the storage system 206 to the storage emulators (204a through 204d) via a network. The storage system 206 has at least one storage unit 208. In this case, one storage unit 208 is connected to the storage system 206. One or more host systems (H1 through H4, 210a through 210d) are connected to the storage emulators (204a through 204d), respectively. The virtual storage system 200 allows a host system (one of 210a through 210d) to control or access the storage unit 208 via the network, in a manner that just as the storage unit 208 is physically coupled to the host system (the one of 210a through 210d). The virtual storage system 200 preferably allows some or all of the host systems (210a through 210d) to control the storage unit 208.

The scheduling apparatus 202 is capable of scheduling a plurality of commands transmitted from the host systems (210a through 210d) to the storage system 206 for accessing the storage unit 208 based on the commands. The scheduling apparatus 202 includes a command-collecting module 212, a sorting module 214 and a command-executing module 216. The command-collecting module 212 is coupled to the sorting module 214, and the sorting module 214 is coupled to the command-executing module 216.

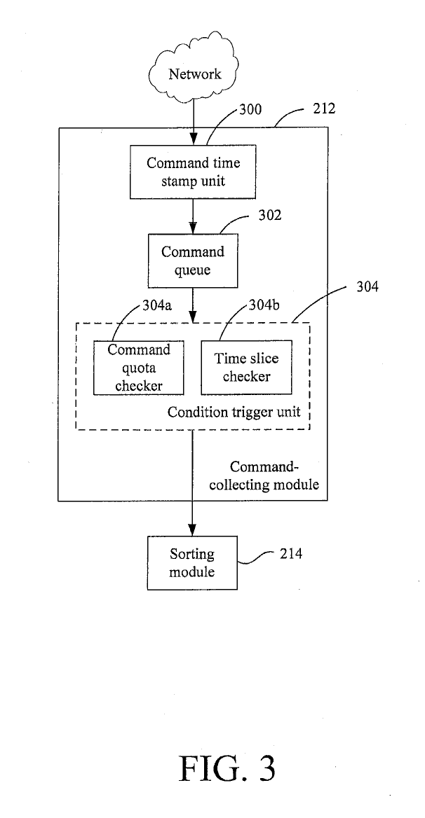

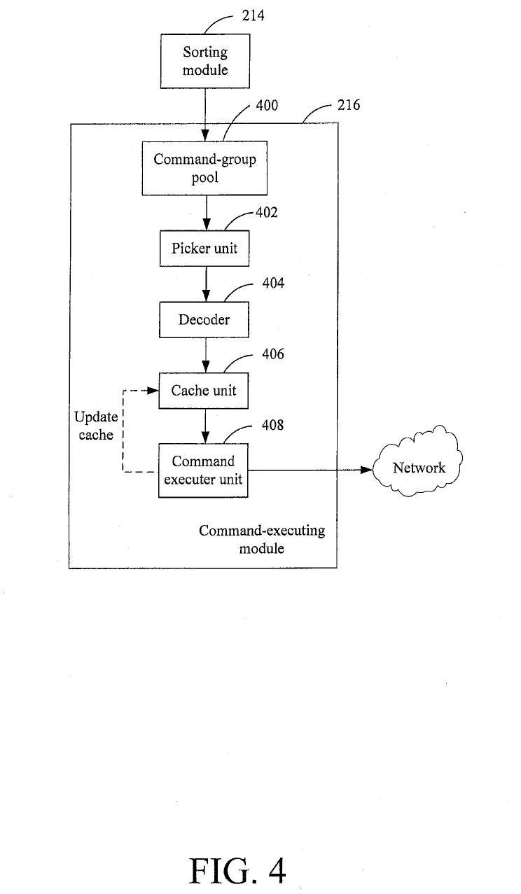

The command-collecting module 212 collects the commands issued from the host systems (210a through 210d). The sorting module 214 sorts the collected commands from the command-collecting module 212 based on a plurality of data addresses The data addresses within the storage unit 208 are associated with the commands. The command executing module 216 executes the sorted commands from the sorting module 214. The command-collecting module 212 and the command executing module 216 will be described in detail by accompanying FIG. 2 with FIGS. 3-4 below.

The storage emulators (204a through 204d) are capable of analyzing the commands from the host systems (210a through 210d) for forwarding a certain type of the commands to the storage system 206. For example, the emulators (204a through 204d) may be designed to forward only read commands and write commands to the storage system 206. And the emulators (204a through 204d) further emulate the storage unit 208 of the storage system 206 as if the storage unit 208 is directly and locally connected to the host systems (210a through 210d), such that the host systems (210a through 210d) are capable of accessing the storage unit 208.

FIG. 3 shows a schematic diagram of an example of a command-collecting module 212 of the scheduling apparatus 202 shown in FIG. 2 consistent with the present invention. The command-collecting module 212 further includes a command time stamp unit 300, a command queue 302, and a condition trigger unit 304. The command time stamp unit 300 coupled to the host systems (210a through 210d) via the network and the storage emulators (204a through 204d). The command queue 302 and the condition trigger unit 304 are sequentially coupled to the sorting module 214.

The command time stamp unit 300 records a plurality of arrival time stamps of the commands from the host systems (210a through 210d). That is, the command time stamp unit 300 “stamps” the arrival time when the commands are sequentially received by the command-collecting module 212. The command queue 302 queues the commands from the command time stamp unit 300. The condition trigger unit 304 groups the commands in the command queue 302 into a plurality of command groups based on plural condition thresholds. The plural condition thresholds may include condition thresholds such as a command quota and a time slice. The command quota is defined as a data amount being accessed by the commands, and the time slice is defined as a time interval. The condition trigger unit 304 further includes a command quota checker 304a and a time slice checker 304b for checking aforesaid two condition thresholds, respectively. The command quota checker 304a checks the data amount being accessed by the commands based on the command quota of the condition threshold. The time slice checker 304b checks the time interval of the arrival time stamps based on the time slice condition threshold. While either one of the two condition thresholds is reached, the commands queued at the command queue 302 are grouped and transmitted to the sorting module 214.

FIG. 4 shows a schematic diagram of an example of a command-executing module 216 of the scheduling apparatus 202 shown in FIG. 2 consistent with the present invention. The command-executing module 216 further includes a command-group pool 400, a picker unit 402, a decoder 404, a cache unit 406, and a command executer unit 408. The command-group pool 400 is coupled to the sorting module 214 and the command executer unit 408 is coupled to the host systems (210a through 210d) in FIG. 2 via the network.

The command groups from the sorting module 214 are stored in a command-group pool 400, wherein each of the command groups has at least one command. The picker unit 402 picks one of the command groups from the command-group pool 400. The decoder 404 decodes the commands within the picked command group according to the data addresses those would be accessed by the commands. The cache unit 406 stores the data corresponding to the data addresses which are previously accessed by the previous commands. If the data being accessed by the current commands have the same address(es) as the data previously accessed by the previous commands, the previously accessed data in the cache unit 406 are transmitted to the host systems (210a through 210d) directly. If the data being accessed by the current commands have the different address(es) from the data previously accessed by the commands, the command executer unit 408 executes the current commands and transmits the corresponding data to the host systems (210a through 210d). Further, the command executer unit 408 updates the cache unit 406 with the current data accessed by the commands if the data being accessed by the current commands have different addresses from the data previously accessed.

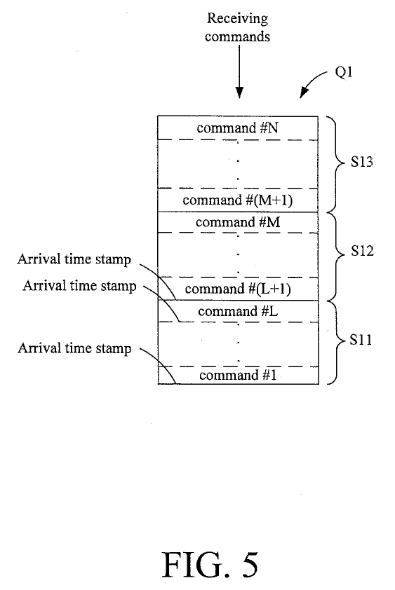

Please refer to FIG. 2, FIG. 3 and FIG. 5. FIG. 5 shows a diagram illustrating an example of dividing time slices for collecting the commands in a command queue (Q1) consistent with the present invention. The command-collecting module 212 receives the commands from the host systems (210a through 210d). For example, the commands include command #1 to command #3N stored into the command queue 202 according to the arrival time stamps. Based on a time slice, the command-collecting module 212 divides the arrival time stamps into a plurality of time slices, such as “S11”, “S12”, and “S13”. The time slices “S11”, “S12”, and “S13” includes commands #1˜#L, commands #(L+1)#M, and commands #(M+1)˜#N, respectively, wherein “L”, “M”, and “N” may be positive integers.

In one embodiment, the interval of the time slice ranges from 500 (μs) to 1000 (μs). In another embodiment, the command quota checker 304a collects the command and the data amount accessed by the command range from 0.5 kbs (kilo-bytes) to 64 kbs It should be noted that the arbitrary ranges of the time slices and the data amount may be utilized. Therefore, the commands are executed so that the virtual storage system 200 with the scheduling apparatus 202 schedules commands to reduce the problem of time-out issue. In one embodiment, the number of users operating in the host systems (210a through 210d) ranges from one to ten, the interval of time slice can be represented by the following formula: (1+n×0.1) (time unit), wherein “n” represents the number of users, and the time slice may be set to two time units if more than a predetermined number of users, say, 10, are present. In addition, the number of users operating in the host systems (210a through 210d) ranges from one to ten, the command quota can be preferably represented by the following formula: (1+n) (bulk unit), wherein “n” represents the number of users, and the command quota may be set to 11 bulk units if more than a predetermined number of users, say, 10, are present.

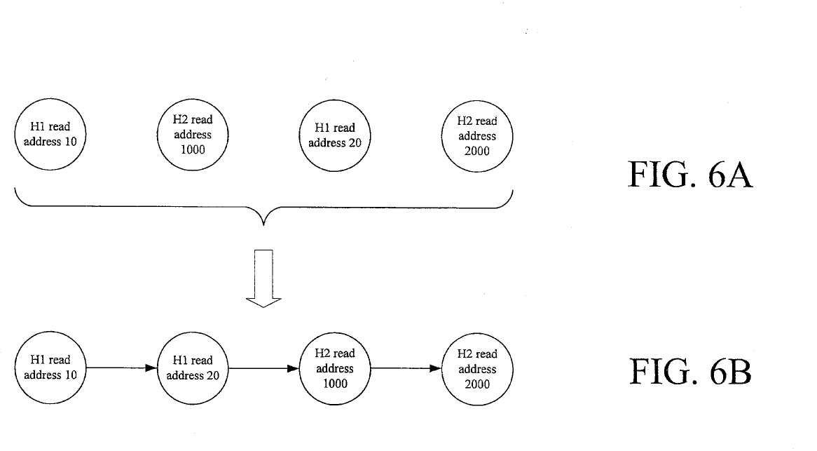

Please refer to FIG. 2 and FIGS. 6A and 6B which depict a diagram illustrating an example of sorting the commands within a time slice consistent with the present invention. In FIG. 6A, according to the arrival time stamp, four commands are in this time slice, they are: host system 210a (H1) reading address “10”, host system 210b (H2) reading address “1000”, host system 210a (H1) reading address “20”, and host system 210b (H2) reading address “2000”. In FIG. 6B, after sorting the four commands in this time slice according to the addresses to be accessed, the commands are sorted as the following order: host system 210a (H1) reading address “10”, host system 210a (H1) reading address “20”, host system 210b (H2) reading address “1000”, and host system 210b (H2) reading address “2000”.

The command-executing module 216 sorts the addresses accessed by the commands on the storage unit 208 from FIG. 6A to FIG. 6B for executing the sorted commands sequentially. The addresses associated with the commands are arranged in sequence to simplify the motion of the read/write head of the storage unit 208. As a result, the virtual storage system 200 with the scheduling apparatus 202 schedules commands for scheduling commands to reduce input/output (I/O) time of the storage unit 208. In one embodiment, the addresses of the commands are addressed based on logical block addressing (LBA) or the physical addressing of the storage unit 208. It should be noted that LBA used in the storage unit 208 (e.g. hard disk drive) may be arbitrary bit number, e.g. 28-bit, 48-bit wide, or more bit wide to be suitable for storage unit 208 with more large capacity.

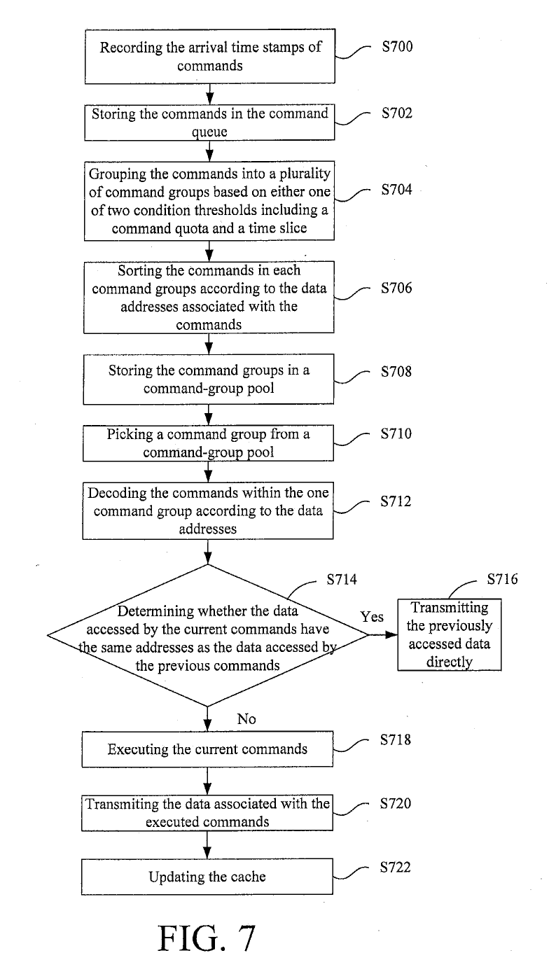

Please refer to FIGS. 2-4 and FIG. 7. FIG. 7 shows a flow chart of performing the scheduling apparatus in the example consistent with the present invention. The flow chart includes the following steps:

In step S700, recording a plurality of arrival time stamps of the commands from the host systems (210a through 210d).

In step S702, queuing the commands in the command queue 302.

In step S704, grouping the commands in the command queue into a plurality of command groups based on plural condition thresholds. The plural condition thresholds may include condition thresholds such as a command quota and a time slice, wherein the command quota is defined as a data amount being accessed by the commands and the time slice is defined as a time interval. While either one of the two condition thresholds is reached, the commands queued by the command queue 302 are grouped and transmitted to the sorting module 214.

In step S706, sorting the commands in each command groups according to the data addresses associated with the commands.

In step S708, storing the command groups in a command-group pool 400.

In step S710, picking one of command groups from the command-group pool 400.

In step S712, decoding the commands within the one command group according to the data addresses accessed by the commands using a decoder 404.

In step S714, determining whether the data being accessed by the current commands have the same address(es) as the data previously accessed by the previous commands. If the data being accessed by the current commands have the same address(es) as the data previously accessed by the previous commands, transmitting the previously accessed data in the cache unit 406 to the host systems (210a through 210d) directly, as shown in step S716. If the data being accessed by the current commands have the different address(es) from the data previously accessed by the commands, executing the current commands from the decoder 404, as shown in step S718.

In step S720, transmitting the data at the address(es) associated with the executed current commands to the host systems (210a through 210d).

In step S722, updating the cache unit 406 with the transmitted data associated the current commands.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A scheduling apparatus for scheduling a plurality of commands transmitted from a plurality of host systems to a storage system having a storage unit via a network, wherein the host systems access the storage unit based on the commands, the scheduling apparatus comprising:
a command-collecting module, for collecting the commands issued from the host systems;
a sorting module, for sorting the collected commands based on a plurality of data addresses, wherein the data addresses within the storage unit are associated with the commands; and
a command executing module, for executing the sorted commands.

2. The scheduling apparatus of claim 1, wherein the command-collecting module further comprises:
a command time stamp unit, for recording a plurality of arrival time stamps of the commands from the host systems;
a command queue, for queuing the commands from the command time stamp unit therein; and
a condition trigger unit, for grouping the commands in the command queue into a plurality of command groups based on either one of a command quota and a time slice, wherein the command quota is defined as a data amount being accessed by the commands and the time slice is defined as a time interval.

3. The scheduling apparatus of claim 2, wherein the condition trigger unit further comprises:
a command quota checker, for checking the data amount being accessed by the commands based on the command quota; and
a time slice checker, for checking the time interval of the arrival time stamps based on the time slice.

4. The scheduling apparatus of claim 2, wherein the command-executing module further comprises:
a command-group pool, for storing the command groups from the condition trigger unit;
a picker unit, for picking one of command groups from the command-group pool; and
a decoder, for decoding the commands within the picked command group according to the data addresses accessed by the commands.

5. The scheduling apparatus of claim 4, wherein the command-executing module further comprises:
a cache unit, for storing the data corresponding to the data addresses which are previously accessed by the previous commands; and
a command executer unit, for executing the commands from the decoder.

6. The scheduling apparatus of claim 5, wherein if the data being accessed by the current command have the same address as the data previously accessed by the command, the previously accessed data in the cache unit are transmitted to the host system directly.

7. The scheduling apparatus of claim 5, wherein if the data being accessed by the current command have different address from the data previously accessed by the command, the command executer unit executes the current command and transmits the data at the current address associated with the current executed command to the host system.

8. The scheduling apparatus according to claim 1, wherein the data addresses of the commands are addressed based on logical block addressing (LBA).

9. A method of scheduling a plurality of commands transmitted from a plurality of host systems to a storage system having a storage unit via a network, wherein the host system accesses the storage unit based on the commands, the method comprising the steps of:
recording a plurality of arrival time stamps of the commands from the host systems;
grouping the commands in the command queue into a plurality of command groups based on either one of a command quota and a time slice, wherein the command quota is defined as a data amount being accessed by the commands and the time slice is defined as a time interval;
sorting the commands in each command groups according to the data addresses associated with the commands;
decoding the commands within the one command group according to the data addresses accessed by the commands; and
determining whether the data being accessed by the current commands have the same addresses as the data previously accessed by the previous commands.

10. The method of claim 9, after the step of recording the arrival time stamps of the commands, further comprising a step of queuing the commands.

11. The method of claim 10, after the step of sorting the commands in each command groups, further comprising a step of storing the command groups in a command-group pool.

12. The method of claim 10, after the step of storing the command groups, further comprising a step of picking one of command groups from the command-group pool.

13. The method of claim 10, during the step of determining whether the data being accessed by the current commands have the same addresses as the data previously accessed by the previous commands, if the data being accessed by the current commands have the same addresses as the data previously accessed by the previous commands, transmitting the previously accessed data to the host systems directly.

14. The method of claim 10, during the step of determining whether the data being accessed by the current commands have the same addresses as the data previously accessed by the previous commands, if the data being accessed by the current commands have the different addresses from the data previously accessed by the commands, executing the current commands.

15. The method of claim 14, further comprising a step of transmitting the data at the addresses associated with the executed current commands to the host systems.

16. The method of claim 15, after the step of transmitting the data at the addresses associated with the executed current commands, further comprising a step of updating a cache with the transmitted data associated the current commands.

17. The method of claim 9, wherein the data addresses of the commands are addressed based on logical block addressing (LBA).
